(19) United States
(12) Patent Application Publication
(10) Pub. No.: US 2003/0094807 A1
(43) Pub. Date: May 22, 2003

(54) Loto 2nd chance

(76) Inventor: Patrick Smith, Los Angeles, CA (US)

Correspondence Address: Patrick Smith, 12335 Santa Monica Blvd., Los Angeles, CA, 90025, US

(21) Appl. No.: 09/996,465

(22) Filed: Nov. 20, 2001

(51) Int. Cl. G09B 19/00

(52) U.S. Cl. 283/51

(57) ABSTRACT

A disqualified, discarded and thrown away lottery ticket that failed to qualify for the lottery, having failed to match the required 3 or 4 or more of the winning numbers chosen at random in the lottery drawing, but did however match 1 or 2 of the numbers chosen, therefore qualifying for a discount on merchandise offered by businesses that are authorized to be participants in the Loto 2nd Chance.

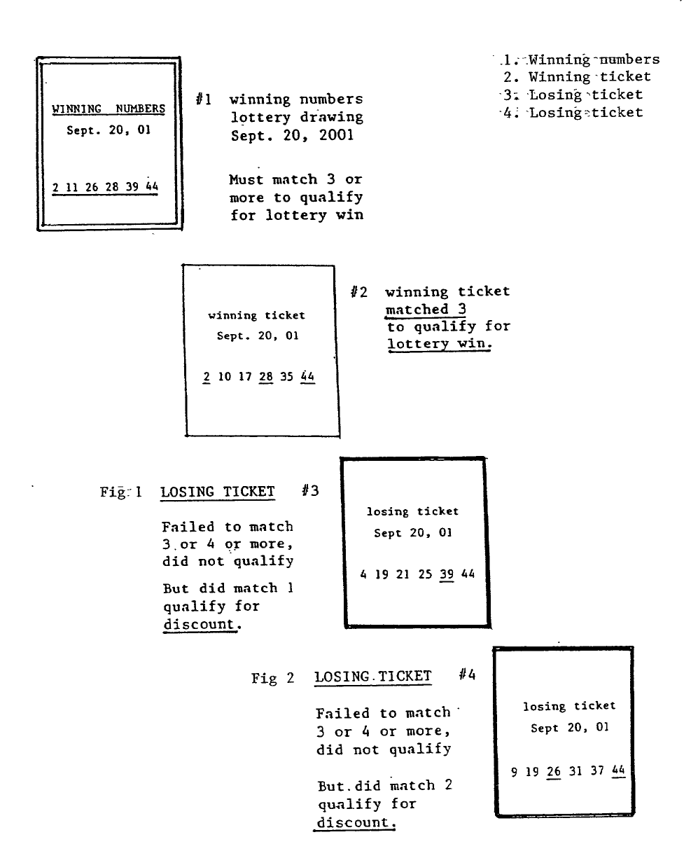

### BACKGROUND OF THE INVENTION

1. Field Of The Invention

This invention pertains, in general, to marketing and in particular, to promotion of merchandise discounts.

1. Description Of The Related Art

The need for promotion of merchandise discounts by business, and the desire for discounts by consumers has not been completely satisfied.

The use of trading stamps, and the use of coupons has not completely filled this need, by business, or the desire by consumers.

Today people consider trading stamps as outdated and would prefer to save money, rather than save stamps.

The use of coupons, although an improvement over trading stamps has not satisfied the need for discounts.

It is therefore an object of the present. invention to provide a method by which the consumer could realize a discount, using something they would normally throw away.

### SUMMARY OF THE INVENTION

These and the other objects and advantages of the present invention are preferable accomplished by the provision of a new, and useful, merchandise, or product, discount tool serving the needs of business and the desire of consumers. A new method, using the disqualified and determined to be ineligible, no longer of any use, and therefore abandoned discarded and thrown away lottery tickets, that failed to match the required 3 or 4 or more winning numbers, chosen at random in the lottery, as necessary to qualify, and be eligible as a winning ticket in the lottery. A new use of an old and known process. By which, when a disqualified, and abandoned and discarded throw away ticket did however match 1 or 2 of the chosen numbers, insufficient for, and ineligible for qualification in the lottery and therefore becoming a throw away item it would be given a 2nd chance to be useful as a product price discount tool serving the needs of business, for an increase in sales of discounted products, and the desire of consumers for price discounts. Consumers could present their losing tickets, that failed to match the required, 3 or 4 or more winning numbers, as necessary to qualify in the lottery, but did match 1 or 2 of the chosen numbers, thereby qualifying for a discount, amount, set by authorized participant in Loto 2nd Chance, example, ticket with 1 number (FIG. #1) might receive 10%, ticket with 2 numbers (FIG. #2) might receive 20% discount.

What is claimed is:

1. A method, by which a consumer discount on merchandise is granted by participating businesses in exchange for the delivery of, the presentation of a disqualified non use throw away lottery ticket that failed to match the required 3 or 4 or more winning numbers chosen in the lottery drawing, and therefore being disqualified, but did however match 1 or 2 of the chosen numbers, and although being an abandoned throwaway ticket because insufficient for and ineligible for the lottery, would however qualify for a discount.

2. A method, by which a consumer discount on merchandise is granted by participating businesses in exchange for the delivery of, the presentation of a disqualified non use throw away lottery ticket that failed to match the required 3 or 4 or more winning numbers chosen in the lottery drawing, and therefore being disqualified, but did however match 1 or 2 of the chosen numbers, and although being an abandoned throwaway ticket because insufficient for and ineligible for the lottery, would however qualify for a discount amount determined by authorized participants in Loto 2nd Chance.
